(19) United States
(12) Patent Application Publication
(10) Pub. No.: US 2022/0382236 A1
(43) Pub. Date: Dec. 1, 2022

(54) SHARED AUTOMATED EXECUTION PLATFORM IN CLOUD

(71) Applicant: SAP SE, Walldorf (DE)

(72) Inventors: Santhosh Reddy MEREDDY, Nalgonda District (IN); Prakash KUMAR, Bangalore (IN); Ravikanth MALIPEDDU, Bangalore (IN); Gaurav MAZUMDAR, Bangalore (IN); Shrijan SHRIVASTAV, Angul/Odisha (IN); Prabhat Kumar SINGH, Ranchi (IN); Praveen JHA, Bangalore (IN); Madhurima CHOWDHURY, Asansol (IN); Sushanth B R, Bangalore (IN)

(21) Appl. No.: 17/332,202

(22) Filed: May 27, 2021

(51) Int. Cl. G05B 19/042; G06F 8/70

(52) U.S. Cl. CPC G05B 19/0426; G05B 19/0423; G06F 8/70; G05B 2219/163; G05B 2219/1169

(57) ABSTRACT

According to some embodiments, a system and method comprising a plurality of automation tools; and a shared automation module, coupled to the plurality of automation tools including: a computer processor; a computer memory, coupled to the computer processor, storing instructions that, when executed by the computer processor cause the shared automation module to: receive a selection of a first automation tool of the plurality of automation tools; receive a selection of a second automation tool of the plurality of automation tools; execute the first automation tool to generate a first automation tool output; and execute the second automation tool using the stored first automation tool output to generate a second automation tool output. Numerous other aspects are provided.

### BACKGROUND

Organizations make use of different automation tools (i.e., software tools) to simplify and execute complex organizational processes (organizational needs). For example, an organization may use a first automation tool to place an order, a second automation tool to validate the order and a third automation tool to validate an invoice. These tools may be automated such that they operate with minimal input from the user. In the case of the first automation tool to place the order, for example, the user may input data into the automation tool, and the tool may generate a sales order number. However, the tools may focus on different domains and may not be able to interact with each other automatically such that a user may be needed to manually input data from one tool to another. This creates a challenge to achieve automation with broader coverage. Additionally, with increased use of applications from a cloud platform, there is an expectation of zero downtime, which may be difficult to achieve with the disparate tools.

Systems and methods are desired which support an efficient shared automation of multiple tools.

### BRIEF DESCRIPTION OF THE DRAWINGS

FIG. 1 is a block diagram of a non-exhaustive example according to some embodiments.

FIG. 2 is a flow diagram according to some embodiments.

FIG. 3 is a block diagram of a non-exhaustive example according to some embodiments.

FIG. 4 is a user interface according to some embodiments.

FIG. 5 is a block diagram according to some embodiments.

FIG. 6 is a block diagram of a system architecture according to some embodiments.

FIG. 7 is a flow diagram according to some embodiments.

FIG. 8 is a block diagram of a system according to some embodiments.

FIG. 9 is a non-exhaustive example of a map according to some embodiments.

### DETAILED DESCRIPTION

The following description is provided to enable any person in the art to make and use the described embodiments and sets forth the best mode contemplated for carrying out some embodiments. Various modifications, however, will remain readily apparent to those in the art.

One or more embodiments or elements thereof can be implemented in the form of a computer program product including a non-transitory computer readable storage medium with computer usable program code for performing the method steps indicated herein. Furthermore, one or more embodiments or elements thereof can be implemented in the form of a system (or apparatus) including a memory, and at least one processor that is coupled to the memory and operative to perform exemplary method steps. Yet further, in another aspect, one or more embodiments or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

In software testing, test automation is the use of software separate from the software being tested, and is used to control the execution of tests and the comparison of actual outcomes with predicted outcomes. Test automation may automate some repetitive but necessary tasks in a formalized testing process already in place, or perform additional testing that would be difficult to do manually. Test automation may be critical for continuous delivery and continuous testing. Conventionally, there are different automation tools available to an organization, where each tool focuses on a different domain. Multiple tools may be used by a user to execute a task, but the tools may be unable to work together in an autonomous fashion.

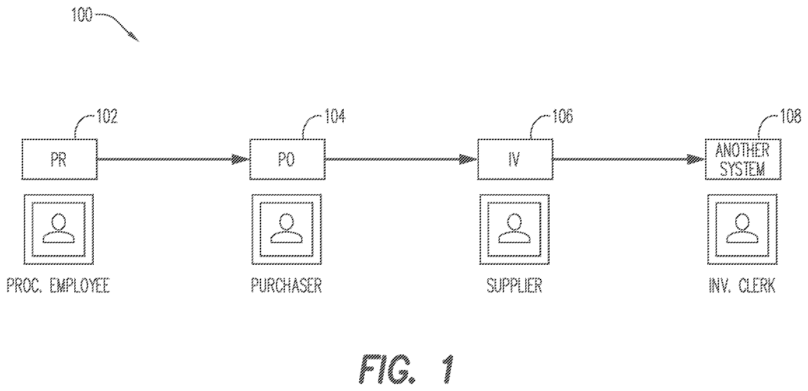

Take, as a non-exahustive example, a case of placing an order. As described above, a user may use a first tool to place an order and generate a sales order number. Then to validate the order, the user may use a second tool. The second tool may need the sales order number generated by the first tool to perform the validation, and this sales order number may be manually input to the second tool by the user. Next, the user may execute a third tool to validate an invoice for the order. For the validation, the third tool may also need the sales order number and other information manually input by the user. For example, FIG. 1 provides a scenario of using different software render tools, a non-exhaustive example of which may be a test automation tool. A purchase requisition (PR) 102 is created using a first software render tool. Non-exhaustive examples of the software render tools used herein may be START by SAP®, the assignee herein, UIVeri5 by SAP®, Vyper, Katalon, CYPRESS, Postman, Karate, JAVA-Selenium, Nightwatch, etc. Then a purchse order (PO) 104, which may be part of the purhcase requisition 102, may be approved by a purchaser with a second software render tool. Subsequently, a Supplier may generate an invoice (IV) 106 for the purchase order 104 using a third test software render tool. Finally, the data may be synced to another system 108 (e.g., Ariba by SAP®, the assignee herein, or any other suitable system) for an inventory clerk to further process using a fourth software render tool.

As another non-exhaustive example, take a case of testing software with respect to a software development environment. Conventionally, teams in an organization may configure virtual machines/physical machines with tooling (e.g., Jenkins open source automation server, software, one or more automation testing tools) installed. The“virtual asset” is created and deployed to simulate the behavior of a real component. The virtual asset is used in place of the real component in situations where the component is required to execute the application under test but is difficult or impossible to access for development and testing purposes. When multiple tools are used for test automation to cover a larger cross-application End to End scenario, there is currently no option to share data between the tools, as each tool is designed to work within themselves. In such instances, users can split the scenario into parts (tests), implemented with different test frameworks. As such, managing the execution of the testing tools may incur significant time and capital for an organization.

It is also noted that software may be updated/upgraded periodically, and this may lead to additional incursion of time and capital when done by every team of an organization. Further, in a case the team(s) uses multiple software render/automation tools, then they may have to track releases/patches and update the tools individually, resulting in additional incursion of time and capital that is scaled up by all the teams in an organization that need to perform these tasks. It is noted that this scale up, while described with respect to a Software Test Environment, is not limited to such an environment and may be applicable to other environments like Production or a Customer-like environment for validation.

Further, while the setup of virtual machine/physical machines may suffice test executions which are small in number, when test executions are scaled to run in hundreds and thousands to ensure software change events are well tested, the virtual machine/physical hardware may not be able to run at scale with the same timely results.

Embodiments provide a shared automation module to configure imports and exports from different tools used in organization processes and with test automation scripts, such that the imports/exports may be shared between the different tools. Using the imports and exports defined for different tools, the shared automation module may capture the data generated by one tool and may then pass that data on to the next tool in the chain, thereby making the organization processes and the test automation scripts inter-operable. The shared automation module may, in one or more embodiments, for example, use an output of a first tool as an input to a second tool via a common interface/API, or other suitable element. In one or more embodiments, the shared automation module may modify the output of a first tool so that it may be input to the second tool. It is noted that as new tools are used by an organization, the shared automation module may advantageously chain (data share) the new tools together with the tools already used by the organization. As such, the shared automation module is extendable to integrate any additional tools and provides for easy automated inter-operability between tools. In one or more embodiments, the tools, as well as the shared automation module, may be hosted on a single cloud platform. The shared automation module may also provide for the automation of maintenance activities of updates/upgrades of different tools.

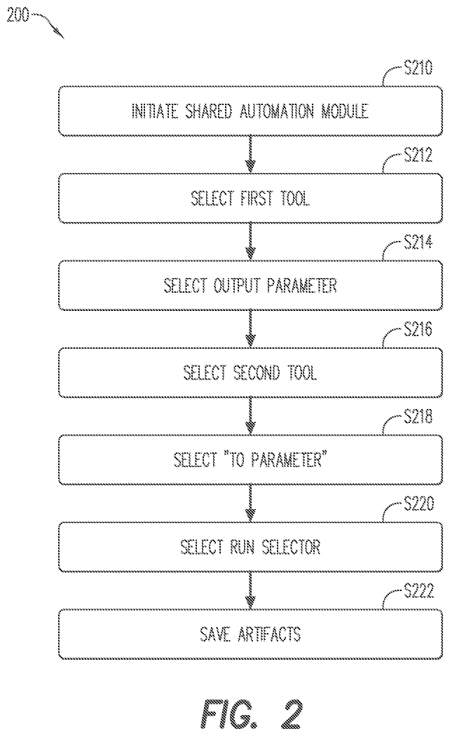

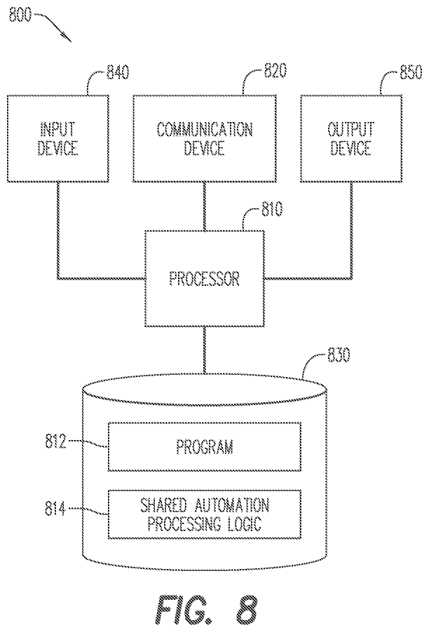

FIG. 2-9 includes flow diagrams of processes 200/700 (FIGS. 2/7) for binding different automation tools to each other on a cloud platform so that the automation tools may share data between them, and executing a request for data, respectively, according to some embodiments. Process 200/700 may be executed by the software architecture 600 according to some embodiments. In one or more embodiments, the software architecture 600 (e.g., cloud platform 606) may be conditioned to perform the process 200/700, such that a processor 810 (FIG. 8) of the system 600/800 is a special purpose element configured to perform operations not performable by a general-purpose computer or device.

All processes mentioned herein may be executed by various hardware elements and/or embodied in processor-executable program code read from one or more of non-transitory computer-readable media, such as a hard drive, a floppy disk, a CD-ROM, a DVD-ROM, a Flash drive, Flash memory, a magnetic tape, and solid state Random Access Memory (RAM) or Read Only Memory (ROM) storage units, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

User interface 400 (FIG. 4) may be presented on any type of display apparatus (e.g., desktop monitor, smartphone display, tablet display) provided by any type of device (e.g., desktop system, smartphone, tablet computer). One or more embodiments may include a UI renderer which is executed to provide user interface 400 and may comprise a Web Browser (e.g., as part of the Web client 603), a standalone application, or any other application. Embodiments are not limited to user interface 400 of FIG. 4.

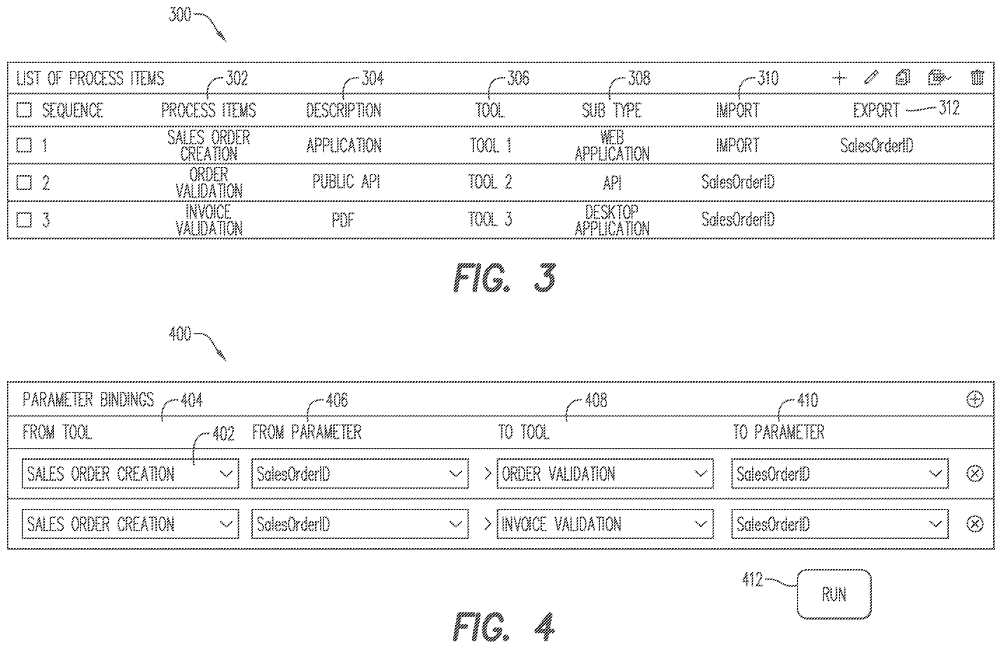

Prior to the process 200 described below, a user (e.g., developer, tester, business users (analysts, consultants), functional experts, Software Product Standard experts) may define the inputs and outputs for a given tool. Each automation tool/software render tool may be a software application that is stored on a cloud platform. The definition may include, but is not limited to, a data type (integer, character, etc.), action, conditional check, input and export parameter, system data container (system under test), target system role (a combination of username and password (e.g., Manager, Approver, Accountant, etc.)). As a non-exhaustive example, FIG. 3 illustrates a list 300 of process items 302 (sales order creation, order validation, invoice validation). Each process item 302 may be executed by a particular software render/automation tool (“tool”) 304. The list 300 may also include a description 306 of the Standard Business Processes or individual entities meant for verification (e.g., S/4 HANA FIORI Application, S/4 HANA Public API, PDF), as well as a sub-type 308 of the types of business application (e.g., Web Application, API, Desktop Application). The list 300 may also include definitions for each import 310 (e.g., SalesOrderID) and export 312 (e.g., SalesOrderID) of the tool 304. It is noted that while import and export shown in FIG. 3 have the same name, the imports/exports may have different names. As used herein, the terms “import” and “input” may be used interchangeably; and the terms “export” and “output” may be used interchangeably.

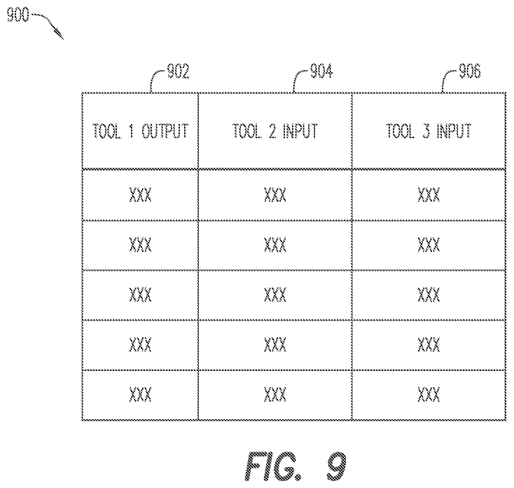

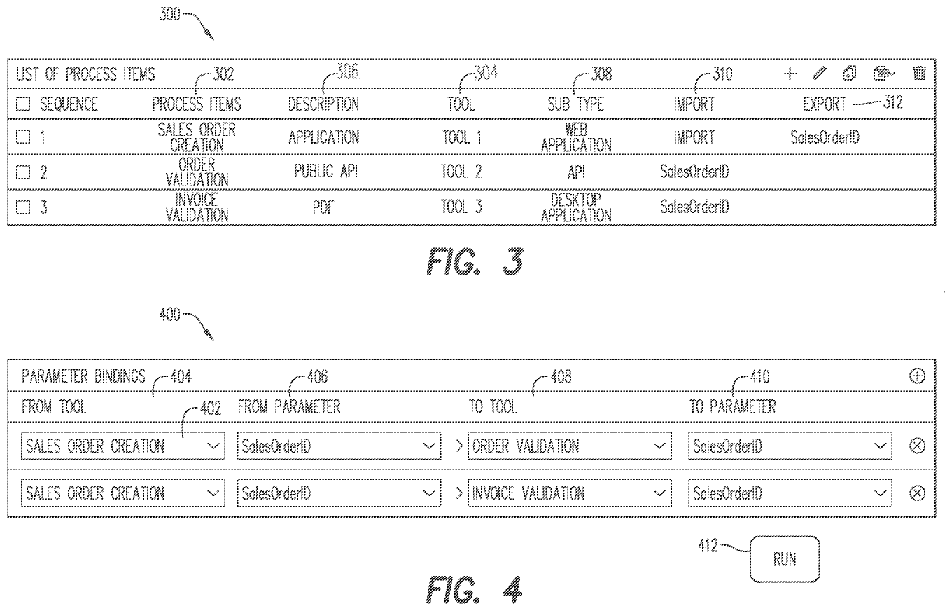

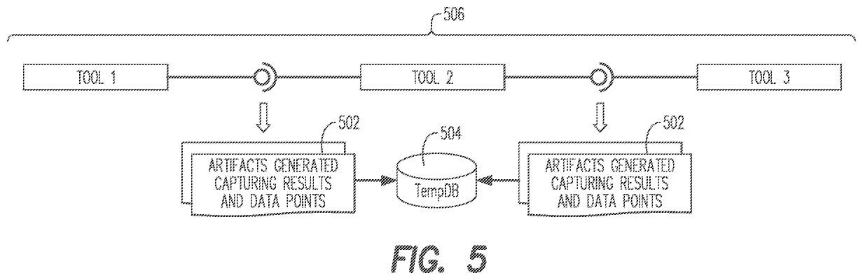

The user may also create a map between different tools of possible data that may be shared between them. For example, the map 900 in FIG. 9 shows that an output 902 of Tool 1 is a Sales Order Number, and this output may be mapped as Created Sales Order Number to be received by Tool 2 as input 904, and/or may be mapped as To be Approved Sales Order Number to be received by Tool 3 as input 906. This mapping may be shown, for example, in the UI 400. It is noted that in some embodiments, the output of one tool may need to be configured before it may be received as input by another tool. The shared automation module 604 may configure the data based on Cloud Platform so that it may be received by the other tool. As a non-exhaustive example, a RDBMS is configured to persist/save the configuration maintained by the user/users. The intermediate export/import, results, logs, etc. may also be stored in this database.

The process 200 described herein will be with respect to the non-exhaustive example of the Sales Order Creation/Order Validation/Invoice Validation business process described above. However, the process 200 may be applied to other business processes and/or test case scenarios. As used herein, the terms “business processes” and “test case scenarios” may be used interchangeably.

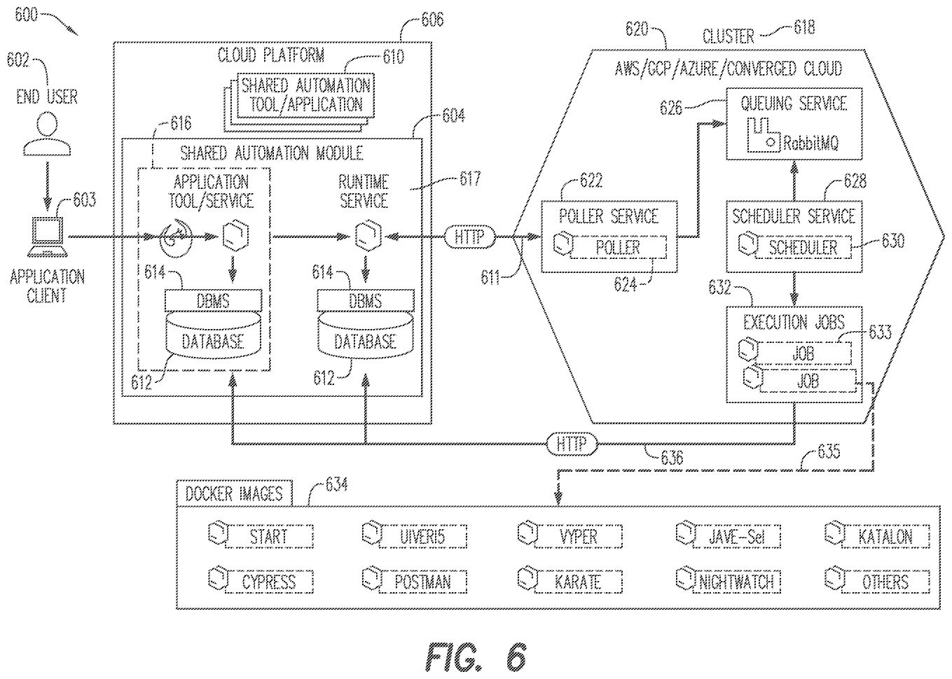

Initially, at S210, a user 602 (FIG. 6) initiates a shared automation module 604 via a user interface. Initiation may be via selection of a shared automation selector (not shown) on the shared automation user interface.

Then in S212, selection of a first tool 304 is received. The selection may be via a drop-down menu 402, as shown in FIG. 4, a radio-button, input to a user-entry field, or any other suitable selection process. It is noted that any of the user selections described in this process 200 may be via any of these described selection processes and may be received by the shared automation module 604, unless otherwise noted. As shown in FIG. 4, the user selects “Sales Order Creation” from a “From Tool” 404 column as the first tool 304.

Next in S214, the user may select an output parameter from a “From Parameter” column 406 as the generated export 312 from the selected first tool 304. In the example shown in FIG. 4, the user selects “SalesOrderID” as the export 312 to be generated by the “Sales Order Creation” tool 304.

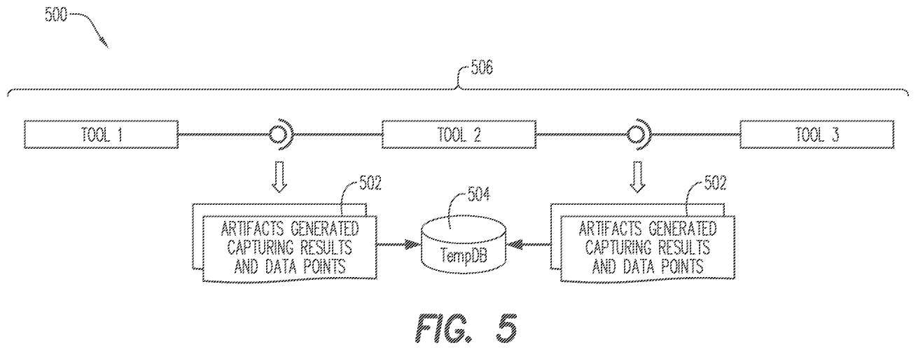

The user selects a second tool 304 to receive the export 312 from the first tool in S216 via selection of a second tool from a “To Tool” column 408. This may be referred to as a “mapping” of the first tool export/output to the second tool input and creates a “chain” or binding 506 (FIG. 5) of tools. It is noted that the tools provided for secondary (anything after the first tool) selection may be populated based on the defined output, as tools are provided that are able to consume the output of the preceding tool based on the user-defined definitions set prior to the process. In the example shown in FIG. 4, the user selects an “Order Validation” tool to export/send the SalesOrderID parameter.

Then, in S218, the user selects from a “To Parameter” column 410, a parameter of the second tool to receive the generated export 312 from the first tool. In the example shown in FIG. 4, the user selects a “SalesOrderID” parameter of the second tool to receive the export “SalesOrderID” generated by the first tool. It is noted that while the example shown in FIG. 4 includes “From Parameter” 406 and a “To Parameter” 410 as having a same name, the parameters may have different names. For example, a “From Parameter” of “SalesOrderID” may be mapped to/received by a “From Parameter” of “OrderNumber.”

In S220, the user may select a Run selector 412 to execute the selected chain of parameter bindings.

Execution of each of the tools may generate one or more artifacts 502 (FIG. 5). As used herein, an artifact is a complex and dependent data object that may either refer to preconfigured parameters (e.g., import parameters, system under execution) or may refer to dynamic parameters/configurations (e.g., transactional data, export parameter, logs, system specific date format, language settings, etc.) created during the execution. The generated artifacts 502 may include the export selected by the user (“results”) 312 as well as data points indicating configurations, transactional data and import parameters.

These artifacts 502 may be saved to a common data store 504 in S222. The common data store 504 may be a temporary database or database 612 as shown in FIG. 6 or any other suitable data store.

In the example described herein, selection of the Run selector 412 may cause the shared automation module 604 to execute the Sales Order Creation tool (first/from tool) to generate the SalesOrderID (from parameter). Then this SalesOrderID as well as the artifacts 502 may be saved to the common data store 504. Next, the shared automation module 604 executes the OrderValidation tool (second/to tool) by retrieving the SalesOrderID (from parameter) of the Sales Order Creation tool from the common data store 504 and inputting it to the mapped SalesOrderID parameter of the Order Validation tool. In this way, the mapped import-export parameters from across the different tools may be processed at run time on the cloud platform.

Execution of the second tool may generate a second tool output/export. The second tool output/export may be at least one of: 1. saved to the common data store 504 for use as input in another tool in the bindings, 2. displayed on a user interface and 3. exported to another tool or program, that is not part of the chain for further manipulation.

In one or more embodiments, the artifacts 502 saved in the common data store 504 may be further configured/manipulated prior to input to a second tool. For example, the shared automation module 604 may change a data type, etc. of the exported data to a suitable form to be received by the following tool. The shared automation module 604 may configure the data based on the map 900, referenced above with respect to FIG. 9.

FIG. 6 is a block diagram of system architecture 600 according to some embodiments. Embodiments are not limited to architecture 600.

Architecture 600 includes a client/end user 602, an application/web client 603, a shared automation module 604, a cloud platform 606, applications 610, a database 612, and a database management system or service (DBMS) 614. The shared tools/applications 610 may comprise server-side executable program code (e.g., compiled code, scripts, etc.) executing within the cloud platform 606 to receive queries from clients 602 and provide results to clients 602 based on data of database 612 per the DBMS 614.

In the example architecture of FIG. 6, the software architecture may include a cloud platform 606. Cloud platform 606 provides any suitable interfaces through which clients 602 may communicate with the shared automation module 604 or applications 610 executing on the cloud platform 606. The cloud platform 606 may provide for chaining or binding the executions of the tools/applications across the different tools/applications. The cloud platform 606 may also support scaling for a large number of executions on the cloud platform.

One or more applications 610 executing on the cloud platform 606 may communicate with DBMS 614 using database management interfaces such as, but not limited to, Open Database Connectivity (ODBC) and Java Database Connectivity (JDBC) interfaces. These types of applications 610 may use Structured Query Language (SQL) to manage and query data stored in database 612.

DBMS 614 serves requests to retrieve and/or modify data of database 612, and also performs administrative and management functions. Such functions may include snapshot and backup management, indexing, optimization, garbage collection, and/or any other database functions that are or become known. DBMS 614 may also provide application logic, such as database procedures and/or calculations, according to some embodiments. This application logic may comprise scripts, functional libraries and/or compiled program code.

Cloud platform 606 may be separated from, or closely integrated with, DBMS 614. A closely-integrated cloud platform 606 may enable execution of server applications 610 completely on the platform, without the need for an additional application server. For example, according to some embodiments, cloud platform 606 may provide a comprehensive set of embedded services which provide end-to-end support for Web-based applications. The services may include a lightweight web server, configurable support for OData, server-side JavaScript execution and access to SQL and SQLScript. The cloud platform 606 may be a platform as a service for creating new applications or extending existing applications in a secure cloud computing environment. The cloud platform 606 may include a runtime service 617 that may provide an intermediate persistence layer for test execution requests as well as business process requests which will be consumed by a poller service 622 deployed in a cluster 618.

Cloud platform 606 may provide application services (e.g., via functional libraries) which applications 610 may use to manage and query the data of database 612. The application services can be used to expose the database data model, with its tables, hierarchies, views and database procedures, to clients. In addition to exposing the data model, cloud platform 606 may host system services such as a search service.

The applications 610 may be made to execute on the cloud platform 606 and makes use of the shared automation module 604. The shared automation module 604 may have multiple instances to support a scalable/increased demand/usage of the service. At any given point in time this cloud platform 606 supports automated executions of different tools, such as test automation tools carrying out the business process automation, and supports processes described herein. The tools/applications 610 may include application code.

The end user/client 602/603 may comprise one or more individuals or devices executing program code of a software application for presenting and/or generating user interfaces to allow interaction with the cloud platform 606 and the shared automation module 604. Presentation of a user interface as described herein may comprise any degree or type of rendering, depending on the type of user interface code generated by the cloud platform 606.

For example, end user 602 may execute the Web client 603 to request and receive a Web page (e.g., in HTML format) from the cloud platform 606 to access the shared automation module 604 via HTTP, HTTPS, and/or Web Socket, and may render and present the UI 400 according to known protocols. The client 602/603 may also or alternatively present user interfaces by executing a standalone executable file (e.g., an .exe file) or code (e.g., a JAVA applet) within a virtual machine.

Database 612 may store data used at least by the shared automation module 604 and the applications 610. For example, database 612 may store values that may be used by the shared automation module 604 during the execution thereof.

Database 612 may comprise any query-responsive data source or sources that are or become known, including but not limited to a structured-query language (SQL) relational database management system. Database 612 may comprise a relational database, a multi-dimensional database, an Extensible Markup Language (XML) document, or any other data storage system storing structured and/or unstructured data. The data of database 612 may be distributed among several relational databases, dimensional databases, and/or other data sources. Embodiments are not limited to any number or types of data sources.

In some embodiments, the data of database 612 may comprise one or more of conventional tabular data, row-based data, column-based data, and object-based data. Moreover, the data may be indexed and/or selectively replicated in an index to allow fast searching and retrieval thereof. Database 612 may support multi-tenancy to separately support multiple unrelated clients by providing multiple logical database systems which are programmatically isolated from one another.

Database 612 may implement an “in-memory” database, in which a full database is stored in volatile (e.g., non-disk-based) memory (e.g., Random Access Memory). The full database may be persisted in and/or backed up to fixed disks (not shown). Embodiments are not limited to an in-memory implementation. For example, data may be stored in Random Access Memory (e.g., cache memory for storing recently-used data) and one or more fixed disks (e.g., persistent memory for storing their respective portions of the full database).

The shared automation module 604 may also include a specific application 610 in the form of an application tool/service 616. The application tool/service 616 may provide a user interface application for users to interact, and for users to configure automated test executions and business processes. The application tool/service 616 may also provide the users with the ability to orchestrate chaining of executions across tools. As described above, at the end of the automated executions of the chained/bound tools, the results of the data entries defined in the mapping are extracted and stored in the common data store. The entries stored in the common data store may be used for the next execution request with mapping entities updated from previous execution requests, thereby providing for the sharing of data across tools. The user configuration (test executions, scheduling, build notifications, test results, data mapping, bindings, definitions) received by the shared automation module 604 may be stored in the data store 612 using the DBMS 614.

The system may also include a cluster 618. The cluster may be a Kubernetes cluster, or any other suitable cluster. The cluster 618 may be a set of nodes that run containerized applications. Containerizing an application may package the application with its dependencies and some necessary services. The cluster 618 may allow containers (including the application with its dependencies and necessary services) to run across multiple machines and environments: virtual, physical, cloud-based and on-premises. The cluster 618 may be comprised of one master node (not shown) and a number of worker nodes on which the services (e.g., poller service, scheduler service, execution job node, etc.) run. A master node may be a virtual machine on the cloud provider which hosts the required services of the cluster, while a worker node may be the virtual machines on the cloud provider where actual automatic executions of the user defined configurations are carried out (e.g., sales order created, sales order approval, etc.). The cluster 618 may also operate on a second cloud platform 620. The inventors note that the shared automation module 604 and cluster 618 may be on the same or different cloud platforms (e.g., module on AWS Cloud Platform, and cluster on GCP Cloud Platform). The second cloud platform 620 may be the same or different from the cloud platform 606 on which the shared automation module 604 is located. Non-exhaustive examples of the second cloud platform 620 are Amazon Web Services®, Google Cloud Platform®, Microsoft Azure®, SAP Converged Cloud®, etc.

A poller service 622 may send a poll 624 to the runtime service 617 to retrieve execution requests (test and business process) 611 that may be stored in a runtime service 617 deployed on the cloud platform 606. The poller service 622 may calculate a priority of the execution request and may push the request 611 to a queuing service 626.

The queuing service 626 may be RabbitMQ® or any other suitable queuing service. RabbitMQ® is an open-source message-broker software that implements an Advanced Message Queuing Protocol and is extended with a plug-in architecture to support Streaming Text Oriented Messaging Protocol, MQ Telemetry Transport and other protocols.

A scheduler service 628 may include a scheduler 630. The scheduler service 628 may connect to the queuing service 626 to retrieve execution requests and calculate the capacity of the cluster resources. In a case that enough resources are available, the scheduler 630 may schedule the executions immediately (execution jobs 633). In one or more embodiments, the scheduler 630 may determine the incoming execution demand versus the available capacity/resources in the cluster to carry out the execution. In a case the incoming demand is on the higher side, the scheduler 630 may send a request to the platform via the cluster API calls to create newer resources after which the executions may be carried out. Otherwise, in a case the demand cannot be fulfilled, the scheduler 630 may keep the demand waiting in the queuing service 626 and once the other ongoing executions are completed and resource are freed, the scheduler 630 may process waiting execution requests from the queuing service 626. In a case that enough resources are not available, the scheduler service 628 may request the addition of more resources to the cluster 618, and the requests are re-queried back to the queuing service 626, for processing at a later time.

The execution jobs node 632 is the test and business process execution environments of the defined tools. The environment may be a containerized environment created from a docker image of a tool. The executions are performed at the execution jobs node 632, and the results may be posted to the application/service 616 and runtime service 617, where they may be temporarily persisted (via the database 612) for data sharing across tools. Additionally, a network channel 635 may connect the execution jobs node 632 to the docker image 634. The execution jobs node 632 may download the run time environment of the specific tools which are required to carry out the execution through the network channel 635. The updates and upgrades of different tools may be built and pushed to the docker image/docker registry 634, which are then used when the test executions are performed.

The docker image 634 is a read-only template that contains a set of instructions for creating a container that can run on the Docker® platform. The docker image 634 may provide a convenient way to reliably package applications, software, and pre-configured server environments. The docker image 634 may contain a runtime environment for each specific software render tool, which can be used to perform automation/execution of the tool. As described above, the docker image 634 is used by the execution jobs node 632 to provide an environment in which to perform the executions configured by the user via the Cluster environment 620, which may provide open network to communicate to multiple runtime image repositories (e.g., Docker Registry).

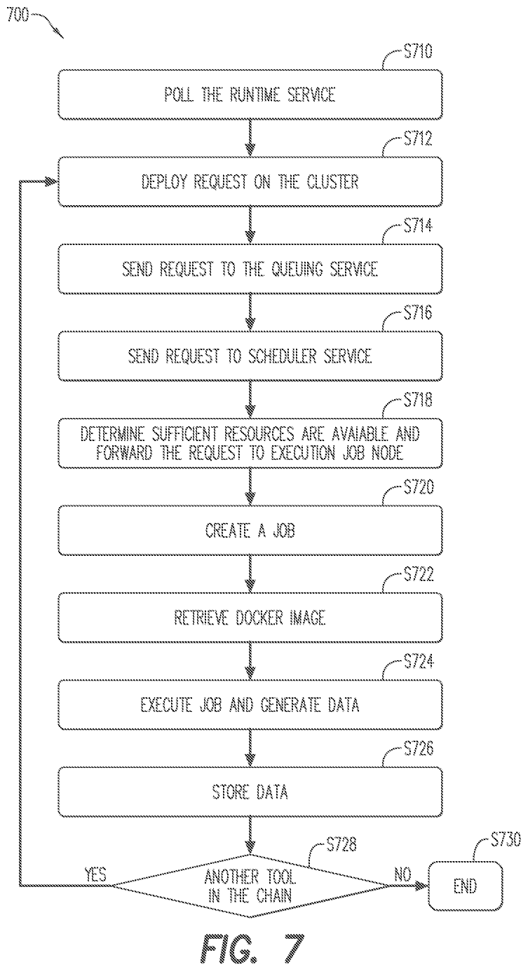

A process 700 for executing a request for data is provided in FIG. 7. Initially, at S710, the runtime service 617 receives a poll 624 from the poller service 622. In response to the poll 624, a request 611 for data is retrieved by the poller service 622 and deployed on the cluster 618 at S712. Then the request 611 may be sent to the queuing service 626 at S714, and forwarded to the scheduler service 628 at S716. Next, at S718, after the scheduler service 628 determines enough cluster resources are available, the request 611 may be deployed by the scheduler service 628 to the execution jobs node 632, where a job (execution job) 633 is created in S720. The execution jobs node 632 next retrieves a docker image 634 for that job 633 at S722, where the docker image 634 includes self-sufficient software. The execution jobs node 632 executes the job 633 using the docker image 634 software etc. and generates data 636 at S724. The data 636 may be returned to the cloud platform 606 for storage in the common data store 612 at S726. Then at S728 it is determined whether there is another tool in the chain of tools. If it is determined at S728 there are no other tools in the chain 506 (e.g., no requests are returned in response to a poll being sent), the process 700 ends at S730. If it is determined at S728 there are other tools in the chain, the process returns to S712, and the process continues as above to execute the second tool, with the execution jobs node 632 substituting the values generated by the first tool as the input for the second tool per the configuration.

FIG. 8 is a block diagram of apparatus 800 according to some embodiments. Apparatus 800 may comprise a general- or special-purpose computing apparatus and may execute program code to perform any of the functions described herein. Apparatus 800 may comprise an implementation of one or more elements of system 600. Apparatus 800 may include other unshown elements according to some embodiments.

Apparatus 800 includes a shared automation processor 810 operatively coupled to communication device 820, data storage device/memory 830, one or more input devices 840, and one or more output devices 850. Communication device 820 may facilitate communication with external devices. Input device(s) 840 may comprise, for example, a keyboard, a keypad, a mouse or other pointing device, a microphone, knob or a switch, an infra-red (IR) port, a docking station, and/or a touch screen. Input device(s) 840 may be used, for example, to manipulate graphical user interfaces and to input information into apparatus 800. Output device(s) 850 may comprise, for example, a display (e.g., a display screen) a speaker, and/or a printer.

Data storage device/memory 830 may comprise any device, including combinations of magnetic storage devices (e.g., magnetic tape, hard disk drives and flash memory), optical storage devices, Read Only Memory (ROM) devices, Random Access Memory (RAM) etc.

The storage device 830 stores a program 812 and/or shared automation logic 814 for controlling the processor 810. It is noted that program 812 and/or shared automation logic 814 may also be stored and executed from an application server or from any other environment (e.g., software architecture) that can execute software instructions. The processor 810 performs instructions of the programs 812, 814, and thereby operates in accordance with any of the embodiments described herein, including but not limited to process as 200/700. The executable instructions of the programs 812, 814 represent the executable instructions of the software architecture, including implementation of the methods, modules, subsystems and components and so forth described herein and may also include memory and/or storage modules, etc.

The programs 812, 814 may be stored in a compressed, uncompiled and/or encrypted format. The programs 812, 814 may furthermore include other program elements, such as an operating system, a database management system, and/or device drivers used by the processor 810 to interface with peripheral devices.

The foregoing diagrams represent logical architectures for describing processes according to some embodiments, and actual implementations may include more or different components arranged in other manners. Other topologies may be used in conjunction with other embodiments. Moreover, each system described herein may be implemented by any number of computing devices in communication with one another via any number of other public and/or private networks. Two or more of such computing devices may be located remotely from one another and may communicate with one another via any known manner of network(s) and/or a dedicated connection. Each computing device may comprise any number of hardware and/or software elements suitable to provide the functions described herein as well as any other functions. For example, any computing device used in an implementation of system 600 may include a processor to execute program code such that the computing device operates as described herein.

All systems and processes discussed herein may be embodied in program code stored on one or more computer-readable non-transitory media. Such non-transitory media may include, for example, a fixed disk, a floppy disk, a CD-ROM, a DVD-ROM, a Flash drive, magnetic tape, and solid-state RAM or ROM storage units. Embodiments are therefore not limited to any specific combination of hardware and software.

The embodiments described herein are solely for the purpose of illustration. Those in the art will recognize other embodiments may be practiced with modifications and alterations limited only by the claims.

1. A system comprising:
a plurality of automation tools; and
a shared automation module, coupled to the plurality of automation tools including:
a computer processor;
a computer memory, coupled to the computer processor, storing instructions that, when executed by the computer processor cause the shared automation module to:
receive a selection of a first automation tool of the plurality of automation tools;
receive a selection of a second automation tool of the plurality of automation tools;
receive a selection of a parameter in the second automation tool from a user to receive a first automation tool output;
execute the first automation tool to generate the first automation tool output;
and
execute the second automation tool using the first automation tool output as the selected parameter in the second automation tool to generate a second automation tool output.

2. The system of claim 1, further comprising a common data store.

3. The system of claim 2, further comprising instructions to:
store the first automation tool output at the common data store prior to execution of the second automation tool.

4. The system of claim 3, wherein execution of the second automation tool further comprises instructions to:
retrieve the first automation tool output from the common data store;
input the first automation tool output to the second automation tool; and
execute one or more scripts of the second automation tool with the input first automation tool output.

5. The system of claim 1, further comprising instructions to:
receive a mapping of a first automation tool output parameter for the first automation tool output to a second automation tool input parameter of the second automation tool.

6. The system of claim 5, wherein execution of the second automation tool further comprises instructions to:
input the first automation tool output for the first automation tool output parameter as input to the mapped second automation tool input parameter.

7. The system of claim 1, wherein each of the plurality of automation tools is a software application.

8. The system of claim 1, wherein each of the plurality of automation tools is stored on a cloud platform.

9. The system of claim 1, wherein execution of the second automation tool using the first automation tool output further comprises instructions to:
configure the first automation tool output to a second automation tool input.

10. The system of claim 1, further comprising instructions to:
receive a selection of a third automation tool of the plurality of automation tools prior to execution of the second automation tool; and
execute the third automation tool using the second automation tool output to generate a third automation tool output.

11. The system of claim 1, further comprising a user interface adapted to receive the selection of the first automation tool and the selection of the second automation tool.

12. A computer-implemented method comprising:
receiving a selection of a first automation tool of a plurality of automation tools;
receiving a selection of a second automation tool of the plurality of automation tools;
receiving a mapping of a first automation tool output to a second automation tool input wherein the mapping is based on a receipt of a selected parameter in the second automation tool from a user to receive the first automation tool output;
executing the first automation tool to generate a first automation tool output;
storing the first automation tool output at a common data store; and
executing, based on the mapping, the second automation tool using the stored first automation tool output as the selected parameter in the second automation tool to generate a second automation tool output.

13. The computer-implemented method of claim 12, wherein execution of the second automation tool further comprises:
retrieving the first automation tool output from the common data store;
inputting the first automation tool output to the second automation tool; and
executing one or more scripts of the second automation tool with the input first automation tool output.

14. The computer-implemented method of claim 12, wherein receiving a mapping of the first automation tool output to a second automation tool input further comprises:
receiving a mapping of a first automation tool output parameter for the first automation tool output to a second automation tool input parameter of the second automation tool.

15. The computer-implemented method of claim 14, wherein execution of the second automation tool further comprises:
inputting the first automation tool output for the first automation tool output parameter as input to the mapped second automation tool input parameter.

16. The computer-implemented method of claim 12, wherein each of the plurality of automation tools is a software application.

17. The computer-implemented method of claim 12, wherein each of the plurality of automation tools is stored on a cloud platform.

18. The computer-implemented method of claim 12, wherein execution of the second automation tool using the stored first automation tool output further comprises:
configuring the first automation tool output to a second automation tool input.

19. A non-transitory, computer readable medium having executable instructions stored therein to perform a method, the method comprising:
receiving a selection of a first automation tool of a plurality of automation tools;
receiving a selection of a second automation tool of the plurality of automation tools;
receiving a mapping of a first automation tool output to a second automation tool input wherein the mapping is based on a receipt of a select d parameter in the second automation tool from a user to receive the first automation tool output;
executing the first automation tool to generate a first automation tool output;
storing the first automation tool output at a common data store; and
executing, based on the mapping, the second automation tool using the stored first automation tool output as the selected parameter in the second automation tool to generate a second automation tool output.

20. The medium of claim 19, wherein each of the plurality of automation tools is stored on a cloud platform.
